(19) United States
(12) Patent Application Publication
(10) Pub. No.: US 2019/0389756 A1
(43) Pub. Date: Dec. 26, 2019

(54) Apparatus and operating method for deep denitrification and toxicity reduction of wastewater

(71) Applicant: NANJING UNIVERSITY, NANJING (CN)

(72) Inventors: HUI HUANG, NANJING (CN); YILIN GAO, NANJING (CN); HONGQIANG REN, NANJING (CN); XUXIANG ZHANG, NANJING (CN); CHONG PENG, NANJING (CN)

(73) Assignee: NANJING UNIVERSITY

(21) Appl. No.: 16/154,966

(22) Filed: Oct. 9, 2018

(30) Foreign Application Priority Data
Jun. 22, 2018 (CN) 201810654970.1

(51) Int. Cl. C02F 9/00; B01F 3/04

(52) U.S. Cl. CPC C02F 9/00; C02F 1/66; B01F 3/04531; B01F 3/04978

(57) ABSTRACT

Disclosed is an apparatus and an operating method for deep denitrification and toxicity reduction of wastewater. The apparatus comprises a regulation tank, an aeration biofilter, an ozone reaction tank, an ozone generation and diffusion device, and a denitrification biofilter. By the coupling reaction treatment of microorganisms, ozone, electrolysis and denitrification, an effect of refractory organic contaminants and nitrate nitrogen removal, deep denitrification and toxicity reduction can be achieved.

### CROSS-REFERENCE TO RELATED APPLICATIONS

This application claims priority to Chinese Patent Application No. 201810654970.1 with a filing date of Jun. 22, 2018. The content of the aforementioned applications, including any intervening amendments thereto, are incorporated herein by reference.

### TECHNICAL FIELD

The present invention relates to an apparatus and an operating method for deep denitrification and toxicity reduction of wastewater.

### BACKGROUND

At present, wastewater mostly has a certain amount of nitrate nitrogen and organic contaminants that are difficult to biodegrade after general secondary treatment. Accumulation of nitrate nitrogen into water after a certain period of time may cause blooms, red tides, etc., which seriously affect the water environment, leading to the deterioration of the natural water environment and the reduction in the amount of fish and shrimp. The organic contaminants that are difficult to biodegrade may have strong biological toxicity and will affect the survival of microorganisms in the receiving water, and they may also affect the cell structure of the algae and animals in the water, leading to biological variation and having great potential environmental impacts. Therefore, attention must be paid to the deep denitrification and toxicity reduction treatment of the wastewater to reduce the content of nitrate nitrogen and organic contaminants that are difficult to biodegrade in the wastewater and minimize the impact on the water environment of the water receiving the same.

Deep denitrification technologies for wastewater comprise ways of anaerobic ammonia oxidation method, common activated sludge method, and biofilm methods etc. The toxicity reduction in the wastewater can be achieved through various ways including advanced electrochemical oxidation, photocatalytic oxidation, adsorption, and ion exchange etc. In the existing wastewater treatment technology, the goal of deep denitrification and toxicity reduction of the wastewater depends on complicated and numerous treatment processes. Most of the current solutions utilize a combination of ozone and biological reactions to treat wastewater, such as: Chinese Patent No.: 201711447463.2, Publication date: Apr. 13, 2018, which discloses a system and a method with a combination of ozone treatment and biofilter for wastewater treatment. The invention relates to a wastewater treatment system for deeply treating organics in the wastewater that are difficult to biodegrade with an ozone treatment device and a biofilter, which can remove the COD difficult to biodegrade in the wastewater in a limited manner. However the organic contaminants entering the ozone treatment device are relative more, the amount of ozone required are relative more, while the ozone content of the ozone-containing air stream provided by the ozone generator is relative lower, so the energy consumption by the ozone generator will increase accordingly, and the system cannot reach the requirement of deep denitrification. Accordingly, designing a process for deep denitrification and toxicity reduction of wastewater with more efficient, simpler, and more convenient for operation is particularly important.

### SUMMARY OF THE INVENTION

With respect to the problems existing in the prior art, the present inventors have found that compared with the conventional direct use of ozone for treating wastewater, the treatment of the wastewater by a microbubble enveloping ozone in the liquid-phase ozone catalyst can improve the utilization of ozone, the biodegradability of the wastewater and the nitrogen removal rate.

The purpose of the present invention is to overcome the disadvantages of the existing apparatus for wastewater, such as complex processing flow, complicated operation, low ozone utilization and poor treatment effect, and provide an apparatus for deep nitrogen removal and toxicity reduction of wastewater.

Specifically, an apparatus for deep denitrification and toxicity reduction of wastewater comprises: a regulation tank connected to a source of wastewater, an agent tank configured to pass through a dosing pipe into the regulation tank for adjusting a pH of the wastewater to 6.5-7.5 by using an agent, an aeration biofilter connected to the regulation tank for removing a portion of organic contaminants and ammonia nitrogen by using aerobic microorganisms, an ozone reaction tank connected to the aeration biofilter for further degrading the remaining organic contaminants in the wastewater to improve the biodegradability of the wastewater, an agitator located inside and at a top of the ozone reaction tank for thoroughly mixing the ozone with the wastewater by stirring, an ultrasonic atomizing diffuser located inside and at the bottom of the ozone reaction tank for diffusing ozone into the wastewater by ultrasonic waves, an ozone generation and diffusion device connected to the ultrasonic atomizing diffuser for providing a gas-liquid mixing medium for ozone, a denitrification biofilter connected to the ozone reaction tank for denitrifying the remaining ammonia nitrogen in the wastewater under an action of the microorganisms for deep denitrification, an ozone detection and flow control assembly connected between the ozone reaction tank and the denitrification biofilter for detecting and decomposing the remaining ozone in an effluent from the ozone reaction tank.

In the above solution, the aeration biofilter comprises: a lower aeration pipe, which is supplied by a gas supply device located outside the aeration biofilter, a first support layer located above the aeration pipe, a first filler layer located above the first support layer for providing an adhesion environment to the microorganisms, a collection tank located above the first filler layer for collecting the wastewater that has been initially treated by the microorganisms and sending it to the ozone reaction tank.

In the above solution, the ozone generation and diffusion apparatus comprises: an ozone generator for producing ozone by using oxygen or an air discharge and providing ozone to the ozone reaction tank, a catalyst storage tank for storing a liquid phase ozone catalyst, a gas-liquid mixing pump connected between the ozone generator and the catalyst storage tank for uniformly mixing the ozone and the liquid phase ozone catalyst and transporting to the ultrasonic atomizing diffuser, an exhaust gas collection processor connected to a top of the ozone reaction tank for collecting and processing the escaped ozone gas.

Particularly suitably, the liquid phase ozone catalyst comprises: 22-31 wt % hydrogen peroxide, 3-5 wt % non-foaming surfactant, 2-4 wt % aqueous dispersant, 8-11 wt % water-soluble chitosan, with a balance of pure water. Hydrogen peroxide may be used as a catalyst for the oxidation of ozone. The non-foaming surfactant may reduce the surface tension of the droplets, and may allow the catalytically decomposed ozone quickly act on the wastewater. The aqueous dispersant is used to maintain the uniform dispersion of the liquid phase catalyst. The water-soluble chitosan is used to form an enveloped outer membrane during ultrasonic disruption, which may prolong the retention time of ozone and decomposed oxygen in water and improve the utilization of ozone.

Particularly suitably, the gas to liquid volume ratio of the ozone to liquid phase ozone catalyst is 1:0.03-0.1.

Particularly suitably, the content of ozone in the wastewater is 1-5 mg/L.

In the above solution, the denitrification biofilter comprises: a partition disposed longitudinally inside the denitrification biofilter for separating the denitrification biofilter into an anode region and a cathode region, wherein a bottom of the anode region is connected to the ozone reaction tank, a bottom of the cathode region drains through the drainage manifold, a second support layer arranged under the anode region and the cathode region, a second filler layer arranged over the second support layer for adsorbing and degrading the organic contaminants, an anode rod embedded in the second filler layer within the anode region and a cathode rod embedded in the second filler layer within the cathode region, a DC power source located external to the denitrification biofilter configured to power the anode rod and the cathode rod.

In the above solution, the ozone detection and flow control assembly comprises a main pipe connected between the ozone reaction tank and the anode region of the denitrification biofilter, an ozone detector disposed on the main pipe for detecting a concentration of the remaining ozone in the drainage, a time-controlled flow valve disposed downstream of the ozone detector for decomposing the remaining ozone by controlling the flow time of the water flow in the main pipe.

In the above solution, the ozone detection and flow control assembly may further comprise: an electronic three-way valve disposed on the main pipe and close to the denitrification biofilter for changing a flow direction of the water flow, a branch pipe connected between the electronic three-way valve and the main pipe upstream of the ozone detector for circulating an unqualified wastewater back to a qualified level.

Particularly suitably, the upper limit of the detection threshold of ozone concentration of the ozone detector is 0.30-0.50 mg/L.

In the above solution(s), first to third pumps are provided between the regulation tank and the aeration biofilter, the aeration biofilter and the ozone reaction tank, the ozone reaction tank and the anode regions of the denitrification biofilter, for pumping the wastewater among the respective containers.

In the above solution(s), a bottom of the aeration biofilter is provided with a first backwash inlet pipe, and an upper of the aeration biofilter is provided with a first backwash outlet pipe connected to the collection tank; a bottom of the denitrification biofilter within the anode region is provided with a second backwash inlet pipe, and a bottom of the denitrification biofilter within the cathode region is provided with a third backwash inlet pipe, a top of the cathode region is connected to the drainage manifold by a second backwash outlet, the first backwash inlet pipe, the second backwash inlet pipe, and the third backwash inlet pipe are provide with first to third backwash pumps, respectively.

Another object of the present invention is to provide an operating method for deep denitrification and toxicity reduction of wastewater, which achieves rapid and efficient deep nitrogen removal. The method comprises the following steps:

1) introducing the wastewater into the regulation tank, adding into the regulation tank NaOH solution or dilute hydrochloric acid contained in the agent tank, adjusting pH to 6.5-7.5, so that the wastewater meets the growth conditions of microorganisms in the aeration biofilter;

2) introducing an effluent from the regulating tank via the first water pump to the aeration biofilter, conducting a hydraulic retention operation for 1-4 hours to removes part of the organic contaminants and ammonia nitrogen by the aerobic microorganisms, which reduces the subsequent processing load of the ozone reaction tank, and also reduce the subsequent amount of ozone to a certain extent;

3) introducing an effluent from the aeration biofilter into the ozone reaction tank and meanwhile, producing ozone from the ozone generator by using oxygen or an air discharge, mixing uniformly with the liquid phase catalyst in the catalyst storage according to a gas to liquid volume ratio of 1:0.03-0.1 by the gas-liquid mixing pump, and introducing into the ultrasonic atomizing diffuser, ultrasonicating into microbubbles enveloping ozone by the ultrasonic atomizing diffuser and dispensing into the wastewater in the ozone reaction tank, so that a content of ozone in the wastewater is 1-5 mg/L, conducting hydraulic retention operation for 4-8 h under stirring by the agitator, the remaining toxic and organic contaminants difficult to biodegrade in the wastewater is further decomposed by the ozone to improve the biodegradability of the wastewater;

4) detecting the wastewater out of the main pipe by the ozone detector, and when the remaining ozone concentration exceeds 0.30-0.50 mg/L, controlling the time-controlled flow valve to extend a retention time of the wastewater thereby spontaneously decomposing the ozone into oxygen and sending to the denitrification biofilter, or when the remaining ozone concentration exceeds 0.30-0.50 mg/L, turning the electronic three-way valve to a circuit connecting the branch pipe and the main pipe, and controlling the time-controlled flow valve to extend the retention time of the wastewater until the remaining ozone concentration in the reflux wastewater is less than 0.30-0.50 mg/L, sending into the denitrification biofilter;

5) subjecting an effluent from the ozone reaction tank to retention operation for 15-20 min in the denitrification biofilter within the anode region, and then overflowing the wastewater from the partition to the cathode region, with a hydraulic retention operation for 15-30 min; the cathode rod receives electrons transmitted by the DC power source and transfers the electrons to the microorganisms in the filler layer, the nitrate nitrogen is reduced by the microorganisms for deep denitrification;

6) backwashing the aeration biofilter and the denitrification biofilter on a regular basis, to remove the accumulated biofilm and prevent the filter layer from clogging.

Specifically, a criteria for the biofilm from appearance to the need of removal is: a biofilm appearance phase from the beginning of the influent to day 7; a biofilm increment phase from day 8 to day 13; a biofilm stabilization phase after day 14. Therefore, a cycle for backwashing is preferably 14 days.

According to one aspect of the present invention, an operating method for deep denitrification and toxicity reduction according to the present invention can be operated in the apparatus according to the present invention.

### The Beneficial Effect of the Present Invention

The invention couples the regulating tank, the biological aerating filter, the ozone reaction tank, the electrolytic cell and the denitrification biofilter, mixes the ozone with the liquid phase catalyst, and pumps into the ultrasonic atomizing diffuser inside of the ozone reaction tank. By uniformly dispersing the microbubbles that contain ozone and its catalyst into the wastewater using ultrasonic waves, the utilization of ozone can be greatly increased. And the organic contaminants that are toxic and difficult to biodegrade in the waste water is further degraded so that the biodegradability of the waste water increase. The invention utilizes various processes to achieve the purpose of deep denitrification and toxicity reduction.

### DRAWINGS OF THE INVENTION

FIG. 1 is a schematic structural view of the apparatus according to a first embodiment of the present invention.

FIG. 2 is a schematic structural view of the apparatus according to a second embodiment of the present invention.

Among them, 1—agent tank, 2—regulation tank, 3—aeration biofilter, 4—ozone reaction tank, 5—ozone generation and diffusion device, 6—denitrification biofilter, 7—collection tank, 8—first filler layer, 9—first support layer, 10—aeration pipe, 11—agitator, 12—ozone generator, 13—catalyst storage tank, 14—gas—liquid mixing pump, 15—ultrasonic atomizing diffuser, 16—exhaust gas collection processor, 17—DC power supply, 18—anode rod, 19—cathode rod, 20—second filler layer, 21—second support layer, 22—partition, 23—ozone detection and flow control assembly, 24—drainage manifold, 25—first backflush inlet pipe, 26—first backwash outlet pipe, 27—second backwash inlet pipe, 28—third backwash inlet pipe, 29—second backwash outlet pipe, 30—main pipe, 31—branch pipe, 32—ozone detector, 33—time—controlled flow valve, 34—three—way valve, 35—first water pump, 36—second water pump, 37—third water pump, 38—first backwash pump, 39—second backwash pump, 40—third backwash pump.

### DETAILED DESCRIPTION OF THE INVENTION

The materials and reagents used in the examples are conventionally used in the art or are commercially available unless otherwise indicated.

### Example 1

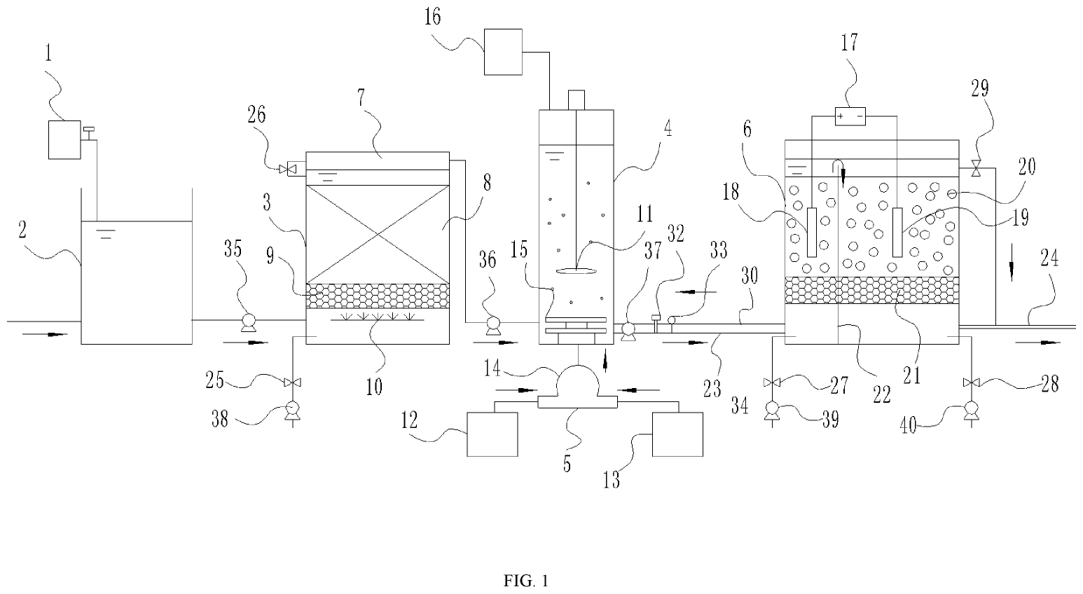

As shown in FIG. 1, an apparatus for deep denitrification and toxicity reduction of wastewater comprises: a regulating tank 2 connected to a wastewater source, which is introduced into the agent tank 1 in the regulating tank 2 through a dosing tube, and adjusts the pH of the wastewater to 7.0 using the agent inside the agent tank 1, and the wastewater is pumped into an aeration biofilter 3 through a first water pump 35, and a part of organic contaminants and ammonia nitrogen is removed by using aerobic microorganisms. The aeration biofilter 3 comprises: a lower aeration pipe 10 supplied by a gas supply device located outside the aeration biofilter 3, a first support layer 9 above the aeration pipe 10, which is a cobblestone layer with a gas-water ratio of 6, a first filler layer 8 above the first support layer 9, which is a ceramsite layer with a particle size of 5 mm and a porosity of more than 50%, and is used for providing an environment for the microorganisms to be attached to the first filler, a collection tank 7 above the first filler layer 8 for collecting wastewater that has been initially treated by microorganisms. The bottom of the aeration biofilter 3 is provided with a first backwash inlet pipe 25, and the upper of the aeration biofilter 3 is provided with a first backwash outlet pipe 26 connected to the collection tank 7, and the first backwash outlet pipe 26 is provided with a first backwash pump 38.

As shown in FIG. 1, the wastewater is pumped from the collection tank 7 by the second water pump 36 to the ozone reaction tank 4 for further degrading the remaining toxic and organic contaminants that are difficult to biodegrade in the wastewater, thereby improving the biodegradability of the wastewater. The ozone and the wastewater are thoroughly mixed by the agitator 11 inside and at the top of the ozone reaction tank 4 by stirring, and the ultrasonic atomizing diffuser 15 at the bottom of the ozone reaction tank 4 is used for diffusing ozone into the wastewater by using ultrasonic waves, and the ozone generation and diffusion device 5 connected to the ultrasonic atomizing diffuser 15 is used for supplying an ozone gas-liquid mixing medium. The ozone generation and diffusion device 5 comprises an ozone generator 12 for producing ozone using oxygen or an air discharge, and providing ozone for the ozone reaction tank 4, a catalyst storage tank 13 for storing a liquid phase ozone catalyst, and a gas-liquid mixing pump 14 connected between the ozone generator 12 and the catalyst storage tank 13 for uniformly mixing the ozone and the liquid-phase ozone catalyst and transporting to the ultrasonic atomizing diffuser 15, and an exhaust gas collection processor 16 connected to the top of the ozone reaction tank 4 for collecting and treating the escaped ozone gas.

As shown in FIG. 1, the third water pump 37 pumps the effluent from the ozone reaction tank 4 to the denitrification biofilter 6 through the ozone detection and flow control assembly 23 to denitrify the remaining ammonia nitrogen in the wastewater under the action of microorganisms and then discharge. The ozone detection and flow control assembly 23 comprises a main pipe 30 connected between the ozone reaction tank 4 and the denitrification biofilter 6 within the anode region, an ozone detector 32 disposed on the main pipe 30 for detecting the remaining ozone concentration in the drainage, and the detection threshold of the ozone concentration of the ozone detector 32 has an upper limit of 0.41 mg/L. A time-controlled flow valve 33 provided downstream of the ozone detector 32 is used to decompose the remaining ozone by controlling the flow time of the water flow in the main pipe 30. The denitrification biofilter 6 comprises a partition 22 arranged longitudinally inside the denitrification biofilter 6 for partitioning the denitrification biofilter 6 into an anode region and a cathode region, wherein the bottom of the anode region is connected to the ozone reaction tank 4, the bottom of the cathode region is drained through the drainage manifold 24, a second support layer 21 arranged under the anode region and the cathode region, a second filler layer 20 arranged over the second support layer 21 for adsorbing and degrading the organic contaminants, an anode rod 18 embedded in the second filler layer 20 within the anode region and a cathode rod 19 embedded in the second filler layer 20 within the cathode region, a DC power source 17 located external to the denitrification biofilter 6 configured to power the anode rod 18 and the cathode rod 19. A second backwash water inlet pipe 27 is provided at the bottom of the anode region of the denitrification biofilter 6, and a third backwash water inlet pipe 28 is provided at the bottom of the cathode region of the denitrification biofilter 6, and the top of the cathode region is connected to the drainage manifold 24 by the second backwash outlet pipe 29, and a second backwash inlet pipe 27 and a third backwash inlet pipe 28 are provided with a second backwash pump 39 and a third backwash pump 40, respectively.

A wastewater containing acrylonitrile was selected with a sampling volume of 100 L. The main water quality indicators were firstly determined by a water quality analyzer as follows: COD=300-330 mg/L, TN=55-60 mg/L, and ammonia nitrogen=27-35 mg/L, NO₃-N=18-22 mg/L.

The wastewater is subject to deep denitrification and toxicity reduction using the present apparatus, comprising:

1) 26.5 wt % hydrogen peroxide solution, 4.2 wt % non-foaming surfactant, 2.9 wt % aqueous dispersant, 9.5 wt % water-soluble chitosan, 56.9 wt % pure water were taken and mixed to form a liquid-phase ozone catalyst, and stored in the catalyst storage 13; wherein, the non-foaming surfactant was polyvinyl alcohol propylene ether, and the aqueous dispersion agent was degradable aqueous polyurethane.

2) The wastewater is introduced into the regulation tank 2, the valve of the agent tank 1 containing dilute hydrochloric acid is opened to adjust the pH to 6.5-7.5 so that the wastewater meets the growth conditions for the microorganisms in the aeration biofilter 3;

3) The effluent from the regulation tank 2 is introduced to the aeration biofilter 3 via the first water pump 35, enter the first filler layer 8 from the bottom of the first support layer 9, and hydraulically operates for 2.5 hours, and a part of the organic contaminants and ammonia nitrogen are removed by the aerobic microorganisms, so that the processing load of the subsequent ozone reaction tank 4 is reduced and also the subsequent amount of ozone to be used is reduced; air is continuously exposed through the aeration pipe 10 located in the lower part by the air pump located outside the aeration biofilter 3, so that the dissolved oxygen concentration in the biofilter 3 is about 3 mg/L;

4) The effluent from the aeration biofilter 3 is collected by the collection tank 7 above the first filler layer 8 and then pumped into the ozone reaction tank 4 via the water pump 36. At the same time, ozone is prepared by the ozone generator 12 by using oxygen or an air discharge, and uniformly mixed with the liquid catalyst in the catalyst storage 13 at a gas-liquid volume ratio of 1:0.08 by the gas-liquid mixing pump 14, and then is introduced into the ultrasonic atomizing diffuser 15 and then ultrasonically atomized and diffused by the ultrasonic diffuser 15 into microbubbles enveloping ozone and is diffused into the wastewater in the ozone reaction tank 4, so that the content of ozone in the wastewater is 3 mg/L. Under the stirring of the stirrer 11, the hydrostatic operation is performed for 6 hours, and the remaining toxic and organic contaminants that are difficult to biodegrade in the wastewater are further degraded by ozone to increase the biodegradability of the wastewater;

5) During the process of pumping the effluent from the ozone reaction tank 4 through the third water pump 37 to the denitrification biofilter 6, the effluent from the ozone reaction tank 4 in the main pipe 30 is first detected by the ozone detector 32. When the concentration of the remaining ozone exceeds 0.41 mg/L, the time-controlled flow valve 33 is controlled to extend the retention time of the wastewater in the pipe, so that the ozone is spontaneously decomposed into oxygen and sent to the denitrification biofilter 6;

6) The effluent from the ozone reaction tank 4 after detection and decomposition enters the anode region from the bottom of the denitrification biofilter 6 and hydraulically operates in the second filler layer 20 for 18 minutes. The remaining ammonia nitrogen in the wastewater is treated by nitrifying bacteria and nitrosobacteria to be converted into nitrate nitrogen, meanwhile the filler and the microorganisms act to adsorb and degrade the organics, then the wastewater overflows from the partition 22 to the cathode region, and is hydraulically operated for 23 min, and the cathode rod 19 receives the electrons transmitted from the DC power source 17, and transmits the electrons to the filler layer 20, the nitrate nitrogen is reduced by the microorganisms and deep denitrification is conducted to remove nitrogen;

7) In a 14-day cycle, clean water is pumped by the first backwash pump 38 at regular intervals, and the aeration biofilter 3 is backwashed by using the first backwash water outlet pipe 26. The backwash water passes through the first backwash water outlet pipe 26 and is collected in the water collection tank 7; the clean water is pumped by the second backwash pump 39 and the third backwash pump 40, and the denitrification biofilter 6 is backwashed by using the second backwash water inlet pipe 27 and the third backflush water inlet pipe 28 to remove the accumulated biofilm to prevent the clogging of the filter layer.

The main water quality indicators for effluent were determined and the results were: COD=20-30 mg/L, TN=2.5-4.5 mg/L, and NO₃-N=1.0-2.0 mg/L. The removal efficiencies were: COD≥90%, TN≥91.8%, and NO₃-N≥92.6%

This example also detected a biological toxicity of the wastewater, the target contaminants were extracted and enriched from the wastewater by SPE, and the biological toxicity of the wastewater was measured by the photobacterium toxicity method. The result was: the inhibition rate of the photobacterium was reduced from 23%±3.5% to 8.5%±2.1%; for the detection of acrylonitrile in the wastewater, -Ln(C/C₀) finally reached 0.90.

### Example 2

Example 2 differs from Example 1 lies in:

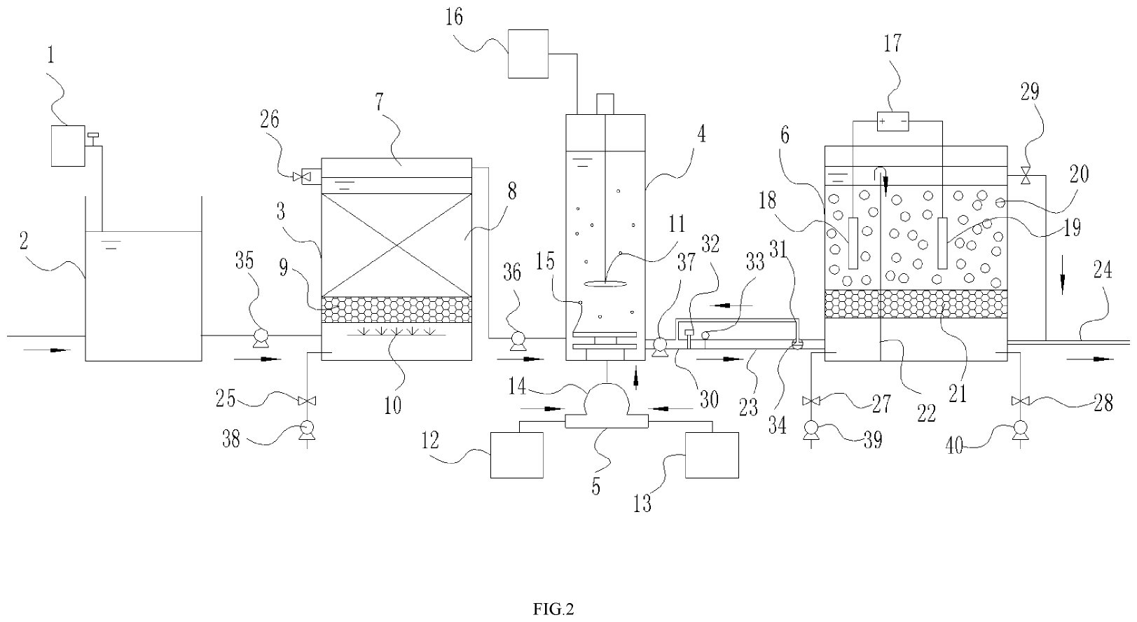

As shown in FIG. 2, the ozone detection and flow control assembly 23 further comprises the electronic three-way valve 34 disposed on the main pipe 30 and close to the denitrification biofilter 6 to change the direction of the water flow, and the branch pipe 31 connected between the three-way electronic the valve 34 and the main pipe 30 upstream of the ozone detector 32 to circulate the unqualified effluent detected to the qualified level.

When the remaining ozone concentration exceeds 0.41 mg/L, the electronic three-way valve 34 turns to the circuit that connects the branch pipe 31 to the main pipe 30 and controls the time-controlled flow valve 33 to extend the residence time of the wastewater in the pipe until the remaining ozone concentration of the reflux in the wastewater is less than 0.41 mg/L and the wastewater is sent to the denitrification biofilter 6.

The main water quality indicators of the effluent were determined and the results were: COD=14-24 mg/L, TN=2.2-4.2 mg/L, and NO₃-N=0.7-1.7 mg/L. The removal efficiencies are: COD≥92%, TN≥92.3%, NO₃-N≥93.7%

In this embodiment, the biological toxicity test is further carried out about the wastewater, the target contaminants were extracted and enriched from the wastewater by SPE, and the biological toxicity of the wastewater was measured by the photobacterium toxicity method. The result was: the inhibition rate of the photobacterium was decreased from 23%±3.5% to 8.3%±2.1%; the acrylonitrile in waste water was detected and -Ln(C/C₀) eventually reached 0.93.

Conclusion: After incorporating the electronic three-way valve 34 and the branch pipe 31 to the ozone detection and flow control assembly 23, since the remaining ozone concentration can be completely controlled within 0.41 mg/L and then discharged into the denitrification biofilter 6, the remaining ozone is completely prevented from affecting the microorganisms in the denitrification biofilter as compared to Example 1, the test results of Example 2 were slightly superior to those of Example 1.

### Example 3

Example 3 differs from Example 2 in that:

In this Example 3, tetracycline-containing antibiotic wastewater was selected for deep denitrification and toxicity reduction treatment. The sampling amount was 100 L. Firstly, the main water quality indicators were determined by a water quality analyzer: COD=295-315 mg/L, TN=56-62 mg/L, NO₃-N=19-22 mg/L.

The main water quality indicators of the effluent were determined and the results were: COD=17-25 mg/L, TN=2.3-4.5 mg/L, and NO₃-N=0.8-1.5 mg/L. The removal efficiencies were: COD≥91.5%, TN≥92.0%, and NO₃-N≥92.1%.

The results for biotoxicity assay showed that the inhibition rate of photobacterium decreases from 21%±3.5% to 7.5%±1.9%; when detection was made to tetracycline in the wastewater, -Ln(C/C₀) finally reached 0.95.

### Example 4

The effect of liquid phase catalysts with different ratios of components on the treatment results was studied:

Taking Example 2 as a reference, 2 control groups were set, 3 parallels were set in each group, and the rest of the conditions were the same. The liquid phase catalysts with different ratios of components were as shown in Table 1. The treatment results of the respective examples were shown in Table 2.

TABLE 1
Liquid phase catalysts with different ratios of components

| | | Non | | Water | |
|---|---|---|---|---|---|
| | Hydrogen | foaming | Aqueous | soluble | Pure |
| Group | peroxide | surfactants | dispersant | chitosan | water |
| Example 2 | 26.5 wt % | 4.2 wt % | 2.9 wt % | 9.5 wt % | 56.9 wt % |
| Comparative | 22 wt % | 3 wt % | 2 wt % | 8 wt % | 65.0 wt % |
| Example 1 | | | | | |
| Comparative | 31 wt % | 5 wt % | 4 wt % | 11 wt % | 49.0 wt % |
| Example 2 | | | | | |

TABLE 2
Treatment results of the respective examples

| | | | | Biological toxicity test | |
|---|---|---|---|---|---|
| | | | | | Acrylonitrile |
| | Effluent quality indicators removal rate | | | | degradation |
| Group | COD | TN | NO₃—N | Photobacterium | rate |
| Example 2 | ≥92% | ≥92.3% | ≥93.7% | 8.3% ± 2.1% | 0.93 |
| Comparative | ≥90.4% | ≥90.7% | ≥91.6% | 8.5% ± 2.1% | 0.90 |
| Example 1 | | | | | |
| Comparative | ≥91.2% | ≥91.5% | ≥92.4% | 8.5% ± 2.1% | 0.92 |
| Example 2 | | | | | |

Results: The results of Comparative Example 1 and Comparative Example 2 were basically the same as those of Example 2, and there was no significant difference.

Conclusion: The liquid phase catalyst of respective components ratios in Example 2 had the best effect on the treatment of wastewater. Therefore, the optimal ratio of liquid phase catalyst is: 26.5 wt % hydrogen peroxide, 4.2 wt % non-foaming surfactant, 2.9 wt % aqueous dispersant, 9.5 wt % water-soluble chitosan, 56.9 wt % pure water.

### Example 5

The effect of different gas-liquid volume ratios of ozone and liquid phase catalysts on the treatment results was studied:

Taking Example 2 as a reference, 4 control groups were set, 3 parallels were set in each group, the amount of ozone and other conditions were the same, and the effect of different gas-liquid volume ratios of ozone and liquid phase catalysts on the treatment results was shown in Table 3.

TABLE 3
Effect of different gas - liquid volume ratios of ozone
and liquid phase catalysts on treatment results

| | Ozone:liquid | Effluent quality indicator | | | Biological toxicity test | |
|---|---|---|---|---|---|---|
| | phase | removal rate | | | | Acrylonitrile |
| Group | catalyst | COD | TN | NO₃—N | Photobacterium | degradation |
| Example 2 | 1:0.08 | ≥92% | ≥92.3% | ≥93.7% | 8.3% ± 2.1% | 0.93 |
| Comparative | 1:0.03 | ≥91.2% | ≥91.6% | ≥92.5% | 8.3% ± 2.1% | 0.93 |
| Example 1 | | | | | | |
| Comparative | 1:0.1 | ≥91.8% | ≥92.0% | ≥93.4% | 8.3% ± 2.1% | 0.93 |
| Example 2 | | | | | | |
| Comparative | 1:0.01 | ≥87.9% | ≥89.8% | ≥90.1% | 8.7% ± 2.1% | 0.88 |
| Example 3 | | | | | | |
| Comparative | 1:0.3 | ≥83.4% | ≥82.6% | ≥86.3% | 8.9% ± 2.1% | 0.87 |
| Example 4 | | | | | | |

Results: The results of Comparative Example 1 and Comparative Example 2 were not much different from those of Example 2. The results of Comparative Example 3 and Comparative Example 4 were significantly lower than those of Example 2.

Conclusion: When the volume ratio of ozone to liquid phase catalyst is too small, the effect of wastewater treatment results will be reduced. However, excessive ratio will cause secondary pollution of the wastewater due to the catalyst and increase the burden of wastewater treatment. The treatment effect is instead not good. The most suitable volume ratio of ozone to liquid catalyst is in the range of 1:0.03-0.1, and the best effect is obtained when the volume ratio is 1:0.08.

### Example 6

The effect of the detection threshold of ozone concentration of the ozone detector on the treatment results was studied:

Taking Example 2 as a reference, 4 control groups were set, 3 parallels were set in each group, the remaining conditions were the same, and the effect of the detection threshold of ozone concentration of the ozone detector on the treatment results was shown in Table 4.

TABLE 4
Effect of Detection threshold of ozone concentration
of the Ozone Detector on Treatment Results

| | Detection | | | | Biological toxicity detection | |
|---|---|---|---|---|---|---|
| | threshold | Effluent water quality indicator | | | | Acrylonitrile |
| | of ozone | removal rate | | | Photobacterium | degradation |
| Group | concentration | COD | TN | NO₃—N | inhibition | rate |
| Example 2 | 0.41 mg/L | ≥92.0% | ≥92.3% | ≥93.7% | 8.3% ± 2.1%% | 0.93 |
| Comparative | 0.30 mg/L | ≥92.3% | ≥92.2% | ≥93.8% | 8.3% ± 2.1% | 0.94 |
| [symbol] | | | | | | |
| Comparative | 0.49 mg/L | ≥91.6% | ≥92.0% | ≥93.2% | 8.3% ± 2.1% | 0.92 |
| [symbol] | mg/L | | | | | |
| Comparative | 0.10 mg/L | ≥92.3% | ≥92.1% | ≥93.7% | 8.3% ± 2.1% | 0.93 |
| [symbol] | | | | | | |
| Comparative | 0.65 mg/L | ≥88.6% | ≥87.9% | ≥88.0% | 8.6% ± 2.1% | 0.84 |
| [symbol] | | | | | | |

[symbol]

indicates data missing or illegible when filed

Results: The results of Comparative Example 1, Comparative Example 2, Comparative Example 3 and Example 2 were not much different, while Comparative Example 4 had a significant decrease in view of each treatment result.

Conclusion: If the detection threshold of ozone concentration is too large, it will lead to higher concentration of ozone entering the denitrification biofilter, affecting the survival of microorganisms, thereby reducing the treatment effect; if the detection threshold of ozone concentration is too small, the treatment results have not obvious interference, however due to the need of reflux in the circuit to achieve a defined threshold concentration by ozone self-decomposition, the length of the entire process increases. The most suitable detection threshold of ozone concentration ranges from 0.3 to 0.5 mg/L, and the best effect is obtained when the detection threshold of ozone concentration is 0.30 mg/L.

### Example 7

The effect of ozone addition mode on wastewater treatment results was studied:

Taking Example 2 as a reference, 3 control groups were set up, 3 parallels were set in each group, and the other conditions were the same. The differences in ozone addition modes among different groups were shown in Table 5; the effect of different groups on the treatment results was shown in Table 6.

TABLE 5
Differences in ozone addition mode among different groups

| | | with or without | with or without |
|---|---|---|---|
| | with or without | liquid phase ozone | ultrasonic |
| Group | ozone | catalyst | atomizing diffuser |
| Example 2 | Yes | Yes | Yes |
| Comparative | Yes | No | No |
| Example 1 | | | |
| Comparative | Yes | No | Yes |
| Example 2 | | | |
| Comparative | Yes | Yes | No |
| Example 3 | | | |

TABLE 6
Effect of different groups on treatment results

| | | | | Biological toxicity test | |
|---|---|---|---|---|---|
| | Effluent water quality | | | | acrylonitrile |
| | indicator removal rate | | | Photobacterium | degradation |
| Group | COD | TN | NO₃—N | inhibition % | rate |
| Example | ≥92.0% | ≥92.3% | ≥93.7% | 8.3% ± 2.1% | 0.93 |
| Compara | ≥81.3% | ≥83.7% | ≥82.1% | 8.9% ± 2.1% | 0.89 |
| Compara | ≥88.6% | ≥89.5% | ≥87.2% | 8.7% ± 2.1% | 0.90 |
| Compara | ≥90.3% | ≥89.0% | ≥89.6% | 8.3% ± 2.1% | 0.90 |

Results: The treatment results of Comparative Example 1, Comparative Example 2, and Comparative Example 3 had different degrees of differences compared with those of Example 2.

Conclusion: Under the condition of ozone only, due to the poor persistence of ozone in water, partial of the ozone can easily escape from the wastewater, which reduces the treatment efficiency; the diffusion conditions of the ultrasonic atomizing diffuser can increase the contact area of the ozone with wastewater, in comparison with the condition of ozone only, it can improve the efficiency of the wastewater treatment; under the condition of ozone and liquid-phase ozone catalyst, the liquid ozone catalyst is not diffused into the form of microbubbles by ultrasound after being mixed with the ozone, although the persistence and treatment efficiency of ozone in water are increased, the contact area ozone with wastewater is reduced to some extent, so the treatment result was worse than that of Example 2. The best combination of ozone addition mode is ozone+liquid phase ozone catalyst+ultrasonic diffusion.

The description of the above embodiments is merely for understanding the method of the present invention and its core idea. It is noted that those skilled in the art can make several improvements and modifications to the present invention without departing from the principle of the present invention, and these improvements and modifications will also fall within the protection scope of the present invention.

We claim:

1. An apparatus for deep denitrification and toxicity reduction of wastewater, comprising:
a regulation tank (2) connected to a source of wastewater,
an agent tank (1) configured to pass through a dosing pipe into the regulation tank (2) for adjusting a pH of the wastewater to 6.5-7.5 by using an agent,
an aeration biofilter (3) connected to the regulation tank (2) for removing a portion of organic contaminants and ammonia nitrogen by aerobic microorganisms,
an ozone reaction tank (4) connected to the aeration biofilter (3) for further degrading the remaining organic contaminants in the wastewater,
an agitator (11) located inside and at a top of the ozone reaction tank (4) for thoroughly mixing the ozone with the wastewater by stirring,
an ultrasonic atomizing diffuser (15) located inside and at the bottom of the ozone reaction tank (4) for diffusing ozone into the wastewater by ultrasonic waves,
an ozone generation and diffusion device (5) connected to the ultrasonic atomizing diffuser (15) for providing a gas-liquid mixing medium for ozone,
a denitrification biofilter (6) connected to the ozone reaction tank (4) for denitrifying the remaining ammonia nitrogen in the wastewater under an action of the microorganisms,
an ozone detection and flow control assembly (23) connected between the ozone reaction tank (4) and the denitrification biofilter (6) for detecting and decomposing the remaining ozone in the effluent from the ozone reaction tank (4).

2. The apparatus according to claim 1, wherein
the aeration biofilter (3) comprising:
a lower aeration pipe (10) and is supplied by a gas supply device located outside the aeration biofilter (3),
a first support layer (9) located above the aeration pipe (10),
a first filler layer (8) located above the first support layer (9) for providing an adhesion environment for the microorganisms,
a collection tank (7) located above the first filler layer (8) for collecting the wastewater that has been initially treated by the microorganisms and sending it to the ozone reaction tank (4),
the ozone generation and diffusion device (5) comprising:
an ozone generator (12) for producing ozone by using oxygen or an air discharge and providing ozone for the ozone reaction tank (4),
a catalyst storage tank (13) for storing a liquid phase ozone catalyst,
a gas-liquid mixing pump (14) connected between the ozone generator (12) and the catalyst storage tank (13) for uniformly mixing the ozone and the liquid phase ozone catalyst and transporting to the ultrasonic atomizing diffuser (15),
an exhaust gas collection processor (16) connected to a top of the ozone reaction tank (4) for collecting and processing the escaped ozone gas,
the denitrification biofilter (6) comprising:
a partition (22) disposed longitudinally inside the denitrification biofilter (6) for separating the denitrification biofilter (6) into an anode region and a cathode region, wherein a bottom of the anode region is connected to the ozone reaction tank (4), a bottom of the cathode region drains through the drainage manifold (24),
a second support layer (21) arranged under the anode region and the cathode region,
a second filler layer (20) arranged over the second support layer (21) for adsorbing and degrading the organic contaminants,
an anode rod (18) embedded in the second filler layer (20) within the anode region and a cathode rod (19) embedded in the second filler layer (20) within the cathode region,
a DC power source (17) located external to the denitrification biofilter (6) configured to power the anode rod (18) and the cathode rod (19),
wherein first to third pumps (35, 36, 37) are provided between the regulation tank (2) and the aeration biofilter (3), the aeration biofilter (3) and the ozone reaction tank (4), the ozone reaction tank (4) and the anode regions of the denitrification biofilter (6), for pumping the wastewater,
wherein a bottom of the aeration biofilter (3) is provided with a first backwash inlet pipe (25), and an upper of the aeration biofilter (3) is provided with a first backwash outlet pipe (26) connected to the collection tank (7);
a bottom of the denitrification biofilter (6) within the anode region is provided with a second backwash inlet pipe (27), and a bottom of the denitrification biofilter (6) within the cathode region is provided with a third backwash inlet pipe (28), a top of the cathode region is connected to the drainage manifold (24) through a second backwash outlet (29),
the first backwash inlet pipe (25), the second backwash inlet pipe (27), and the third backwash inlet pipe (28) are provide with first to third backwash pumps (38, 39, 40), respectively,
wherein the ozone detection and flow control assembly (23) comprising:
a main pipe (30) connected between the ozone reaction tank (4) and the anode region of the denitrification biofilter (6),
an ozone detector (32) disposed on the main pipe (30) for detecting a concentration of the remaining ozone in the drainage,
a time-controlled flow valve (33) disposed downstream of the ozone detector (32) for decomposing the remaining ozone by controlling the flow time of the water flow in the main pipe (30).

3. The apparatus according to claim 2, wherein the ozone detection and flow control assembly (23) further comprises:
an electronic three-way valve (34) disposed on the main pipe (30) and close to the denitrification biofilter (6) for changing a flow direction of the water flow,
a branch pipe (31) connected between the electronic three-way valve (34) and the main pipe (30) upstream of the ozone detector (32) for circulating an unqualified wastewater back to a qualified level.

4. A method for denitrification treatment of wastewater using the apparatus of claim 2, comprising the steps of:
1) introducing the wastewater into the regulation tank (2), adding NaOH solution or dilute hydrochloric acid contained in the agent tank (1), adjusting pH to 6.5-7.5;
2) introducing an effluent from the regulating tank (2) via the first water pump (35) to the aeration biofilter (3), conducting a hydraulic retention operation for 1-4 hours;
3) introducing an effluent from the aeration biofilter (3) into the ozone reaction tank (4) and feeding to the gas-liquid mixing pump (14) according to a gas to liquid volume ratio of ozone: liquid phase ozone catalyst of 1:0.03-0.1, and mixing uniformly, and then ultrasonicating into microbubbles enveloping ozone by the ultrasonic atomizing diffuser (15), and controlling a content of ozone in the wastewater to 1-5 mg/L, and conducting hydraulic retention operation for 4-8 h under stirring by the agitator (11);
4) detecting the wastewater out of the main pipe (30) by the ozone detector (32), and controlling the time-controlled flow valve (33) to extend a retention time of the wastewater thereby spontaneously decomposing the ozone into oxygen and sending to the denitrification biofilter (6) when the remaining ozone concentration exceeds 0.30-0.50 mg/L, or turning the electronic three-way valve (34) to a circuit connecting the branch pipe (31) and the main pipe (30) when the remaining ozone concentration exceeds 0.30-0.50 mg/L, and controlling the time-controlled flow valve (33) to extend the retention time of the wastewater until the remaining ozone concentration in the reflux wastewater is less than 0.30-0.50 mg/L, sending into the denitrification biofilter (6);
5) subjecting an effluent from the ozone reaction tank (4) to retention operation for 15-20 min in the denitrification biofilter (6) within the anode region, and then overflowing the wastewater from the partition (22) to the cathode region, with a hydraulic retention operation for 15-30 min;
6) backwashing the aeration biofilter (3) and the denitrification biofilter (6) on a regular basis.

5. The method according to claim 4, wherein the liquid phase ozone catalyst comprising: 22-31 wt % hydrogen peroxide, 3-5 wt % non-foaming surfactant, 2-4 wt % aqueous dispersant, 8-11 wt % water soluble chitosan, with pure water as the balance.

6. The method according to claim 4, wherein the ozone and the liquid phase ozone catalyst has the gas to liquid volume ratio of 1:0.03-0.1.

7. The method according to claim 4, wherein a threshold for ozone concentration detection of the ozone detector (32) is in the range of 0.30-0.50 mg/L.

8. A method for denitrification treatment of wastewater using the apparatus of claim 3, comprising the steps of:
1) introducing the wastewater into the regulation tank (2), adding NaOH solution or dilute hydrochloric acid contained in the agent tank (1), adjusting pH to 6.5-7.5;
2) introducing an effluent from the regulating tank (2) via the first water pump (35) to the aeration biofilter (3), conducting a hydraulic retention operation for 1-4 hours;
3) introducing an effluent from the aeration biofilter (3) into the ozone reaction tank (4) and feeding to the gas-liquid mixing pump (14) according to a gas to liquid volume ratio of ozone: liquid phase ozone catalyst of 1:0.03-0.1, and mixing uniformly, and then ultrasonicating into microbubbles enveloping ozone by the ultrasonic atomizing diffuser (15), and controlling a content of ozone in the wastewater to 1-5 mg/L, and conducting hydraulic retention operation for 4-8 h under stirring by the agitator (11);
4) detecting the wastewater out of the main pipe (30) by the ozone detector (32), and controlling the time-controlled flow valve (33) to extend a retention time of the wastewater thereby spontaneously decomposing the ozone into oxygen and sending to the denitrification biofilter (6) when the remaining ozone concentration exceeds 0.30-0.50 mg/L, or
turning the electronic three-way valve (34) to a circuit connecting the branch pipe (31) and the main pipe (30) when the remaining ozone concentration exceeds 0.30-0.50 mg/L, and controlling the time-controlled flow valve (33) to extend the retention time of the wastewater until the remaining ozone concentration in the reflux wastewater is less than 0.30-0.50 mg/L, sending into the denitrification biofilter (6);
5) subjecting an effluent from the ozone reaction tank (4) to retention operation for 15-20 min in the denitrification biofilter (6) within the anode region, and then overflowing the wastewater from the partition (22) to the cathode region, with a hydraulic retention operation for 15-30 min;
6) backwashing the aeration biofilter (3) and the denitrification biofilter (6) on a regular basis.

9. The method according to claim 8, wherein the liquid phase ozone catalyst comprising: 22-31 wt % hydrogen peroxide, 3-5 wt % non-foaming surfactant, 2-4 wt % aqueous dispersant, 8-11 wt % water soluble chitosan, with pure water as the balance.

10. The method according to claim 8, wherein the ozone and the liquid phase ozone catalyst has the gas to liquid volume ratio of 1:0.03-0.1.

11. The method according to claim 8, wherein a threshold for ozone concentration detection of the ozone detector (32) is in the range of 0.30-0.50 mg/L.
